(19) United States
(12) Patent Application Publication
(10) Pub. No.: US 2026/0042623 A1
(43) Pub. Date: Feb. 12, 2026

(54) BERREL-FEEDING APPARATUS WITH BUCKET SEPARATION FUNCTION

(71) Applicant: Suzhou Cai Machine Group Co., Ltd, Suzhou (CN)

(72) Inventors: Fuzhen Wang, Suzhou (CN); Zhiguo Xiao, Suzhou (CN)

(21) Appl. No.: 19/359,680

(22) Filed: Oct. 15, 2025

(30) Foreign Application Priority Data
Nov. 1, 2024 (CN) 202422662277.2

(51) Int. Cl. B65G 59/10

(52) U.S. Cl. CPC B65G 59/108; B65G 2201/0258

(57) ABSTRACT

The present disclosure relates to a bucket-feeding apparatus with bucket separation function, comprising: a bucket-infeed assembly that includes a guide bracket, and a bucket-separating assembly that includes a wheel unit and a power-source unit. The guide bracket is used to guide the conveying direction of buckets. The wheel unit is drivingly connected to the power-source unit, and the surface of the wheel unit is provided with a helical groove whose thread pitch gradually increases. The outer surface of the bucket body has a rim portion, the rim portion contacting the helical groove. When the wheel unit rotates, the bucket is driven and guided by the guide bracket, and because the thread pitch of the helical groove gradually increases, the spacing between adjacent buckets moving along the wheel unit gradually enlarges; the negative-pressure suction between stacked buckets is decomposed many times, thereby reducing the load required during separation.

### CROSS-REFERENCE TO RELATED APPLICATIONS

This application claims priority to Chinese patent No. 202422662277.2 filed on Nov. 1, 2024, entitled “Bucket-feeding apparatus with bucket separation function”, the entire contents of which are incorporated herein by reference.

### TECHNICAL FIELD

The present disclosure relates to the field of material-distributing mechanisms, and particularly to a bucket-feeding apparatus with bucket separation function.

### BACKGROUND

In pad-printing technology, there is situation that workpieces to be printed are buckets. For convenient storage, buckets to be printed and buckets after printing are stacked together. Although such a storage method greatly saves space, the stacking of buckets will create negative-pressure cavities between successive buckets.

The large depth of the buckets results in a larger negative pressure chamber formed after stacking the two barrels. A large pulling force is thus required to separate the stacked buckets when separating them. Generally, after separation, the bucket is loaded into a printing mold. In existing separating mechanism, the rear bucket is fixed and the front bucket is pushed by a push rod; after separation, the push rod pushes the front bucket into the printing mold. Since the above separating method forcibly overcomes the large suction power caused by the negative-pressure between buckets, the push rod must provide a large pushing force. The large suction power and the large pushing force not only easily damage the separated front bucket, but also cause the front bucket to have large kinetic energy when it is released. Consequently, the stability of the bucket's incoming posture is poor because it is affected by the negative pressure, i.e., the front bucket is easily offset, which affects the accuracy of its position relative to the printing mold, resulting in low bucket-feeding efficiency and large load.

### SUMMARY

To solve the above technical problems, embodiments of the present disclosure provide the following technical solutions:

A bucket-feeding apparatus with bucket separation function, configured for conveying buckets, each of the buckets including a main body, a rim portion on an outer surface of the main body, and a handle; the bucket-feeding apparatus including:
a bucket-infeed assembly, each including two brackets configured to guide a conveying direction of the buckets; and
a bucket-separating assembly, including at least a power-source unit and two wheel units connected to and driven by the at least a power-source unit respectively, wherein:
the wheel unit defines a helical groove on a surface thereof, a thread pitch of the at least a helical groove gradually increases; the helical groove is capable of receiving at least part of the rim portion;
the bucket-separating assembly includes a first wheel and a second wheel in the two wheel unit respectively; the helical groove is defined on a surface of the first wheel and the second wheel, the helical groove on the first wheel and the helical groove on the second wheel are symmetrically arranged; the first wheel and the second wheel rotate in opposite directions and are configured for clamping the bucket therebetween;
the two guide brackets are arranged substantially in parallel and configure for being pressed against by two ends of the handle;
the wheel unit includes an initial end and a terminal end at a relatively upstream and downstream of the conveying direction, respectively; the bucket-separating assembly further includes a positioning unit arranged close to the initial end, the positioning unit is capable of being connected with the handle and driving the handle to rotate relative to the main body.
the positioning unit includes a cylinder, a first rotating block, a stop block and a first elastic member;
the first rotating block is connected to a power output end of the cylinder, under the driving of the cylinder the first rotating block moves along the conveying direction;
the first rotating block is rotatably connected to the stop block, the first elastic member is connected between the first rotating block and the stop block; the stop block is configured for contacting the handle.

In one embodiment, the positioning unit further includes an adjusting bracket and a movable bracket; the cylinder is connected to the movable bracket, the first rotating block is mounted on the adjusting bracket, the adjusting bracket is connected to the power output end of the cylinder;
a position of the cylinder is adjustable relative to the movable bracket along a first linear direction, positions of the adjusting bracket and the first rotating block are adjustable relative to the power output end of the cylinder along a second linear direction, the first linear direction, the second linear direction and the conveying direction are mutually perpendicular.

In one embodiment, a groove width of the helical groove maintains the same, and the thread pitch of the helical groove increases proportionally.

In one embodiment, bucket-feeding apparatus further includes at least a bucket-pushing assembly arranged at the terminal end of the wheel unit;
each of the at least a bucket-pushing assembly includes a linear driving unit and a clamp unit, the clamp unit is mounted on the power output end of the linear driving unit.

In one embodiment, each of the at least a bucket-pushing assembly further includes a second clamp unit, the second clamp unit is mounted on the same power output end of the linear driving unit together with the clamp unit.

In one embodiment, the number of the at least a bucket-pushing assembly is two, the two bucket-pushing assemblies are substantially symmetrically arranged;
the clamp unit includes a rotary push block, a second rotating block, a buffer member, and a second elastic member;
the rotary push block is rotatably connected to the second rotating block, the second elastic member is connected between the rotary push block and the second rotating block;
the rotary push block includes a protrusion on a side thereof facing another bucket-pushing assembly, the protrusion includes a slope facing the terminal end and a mounting face opposite to the slope, the buffer member is connected to the mounting face, an angle between the slope and the mounting face is an acute angle.

In one embodiment, the second clamp unit and the clamp unit are vertically arranged for contacting an upper side and a down side of the bucket, respectively.

The present disclosure has at least the following beneficial effects: in the present disclosure, the rim portion is at least partially received in the helical groove; the bucket is driven to move by the rotation of the wheel unit. Because the thread pitch of the helical groove gradually increases, the spacing between adjacent buckets moving along the wheel unit gradually enlarges; the suction power generated by the negative-pressure formed in the negative-pressure cavity between stacked buckets is decomposed many times. Compared with directly pulling apart the buckets in one step, the load required during separation is reduced, and the stability of the bucket's incoming posture is ensured.

### BRIEF DESCRIPTION OF DRAWINGS

To more clearly illustrate the technical solutions in the present disclosure or prior art, a brief description of the accompanying drawing to be used in the description of the embodiments or prior art will be given below. The drawings described below are obviously just embodiment/embodiments of the present disclosure. For ordinary technicians in this field, other drawings can be obtained based on the drawing without doing creative work.

FIG. 1 is a schematic view of the bucket-feeding apparatus with bucket separation function provided in one embodiment of the present disclosure from a first perspective.

FIG. 2 is a schematic view of the bucket-feeding apparatus with bucket separation function provided in one embodiment of the present disclosure from a second perspective.

FIG. 3 is an enlarged partial view of portion “A” in FIG. 2.

FIG. 4 is a schematic view of the separating unit provided in one embodiment of the present disclosure.

FIG. 5 is a three-dimensional structure view of a positioning unit provided in one embodiment of the present disclosure.

FIG. 6 is a three-dimensional structure view of a clamp unit provided in one embodiment of the present disclosure.

### REFERENCE NUMERALS

100, bucket-infeed assembly; 110, guide bracket; 200, bucket-separating assembly; 210, wheel unit; 220, power-source unit; 230, positioning unit; 211, first wheel; 212, second wheel; 2101, helical groove; 2102, thread tooth; 2103, initial end; 2104, terminal end; 231, cylinder; 232, first rotating block; 233, stop block; 234, first elastic member; 235, first pivot shaft; 236, first limit rod; 237, fixed rod; 238, adjusting bracket; 239, movable bracket; 300, bucket-pushing assembly; 310, linear driving unit; 320, clamp unit; 330, second clamp unit; 321, rotary push block; 322, second rotating block; 323, buffer member; 324, second elastic member; 325, second pivot shaft; 326, second limit rod; 327, protrusion; 3271, slope; 3272, mounting face; 40, bucket; 41, rim portion; 42, handle; 45, main body.

### DESCRIPTION OF EMBODIMENTS

To make the objectives, technical solutions and advantages of the embodiments of the present disclosure clearer, the technical solutions of the embodiments of the present disclosure will be described clearly and completely below with reference to the accompanying drawings. Obviously, the described embodiments are part of the embodiments of the present disclosure, not all of them. Based on the described embodiments of the present disclosure, all other embodiments obtained by a person of ordinary skill in the art without creative effort shall fall within the scope of protection of the present disclosure.

Unless otherwise defined, technical or scientific terms used in the present disclosure shall have the usual meanings understood by a person of ordinary skill in the art to which the present disclosure belongs. The terms “first”, “second” and similar expressions used in the present disclosure do not indicate any order, quantity, or importance, but are only used to distinguish different components. Likewise, the expressions “a” or “an” and similar expressions do not indicate a quantity limit, but indicate the presence of at least one. The terms “connected” or “coupled” and similar expressions are not limited to physical or mechanical connections, but can include electrical connections, whether direct or indirect. The terms “upper”, “lower”, “left”, “right” and the like are only used to indicate relative positional relationships, and when the absolute position of the described object changes, the relative positional relationship also changes accordingly.

The embodiments of the present disclosure will be described in detail below with reference to the drawings.

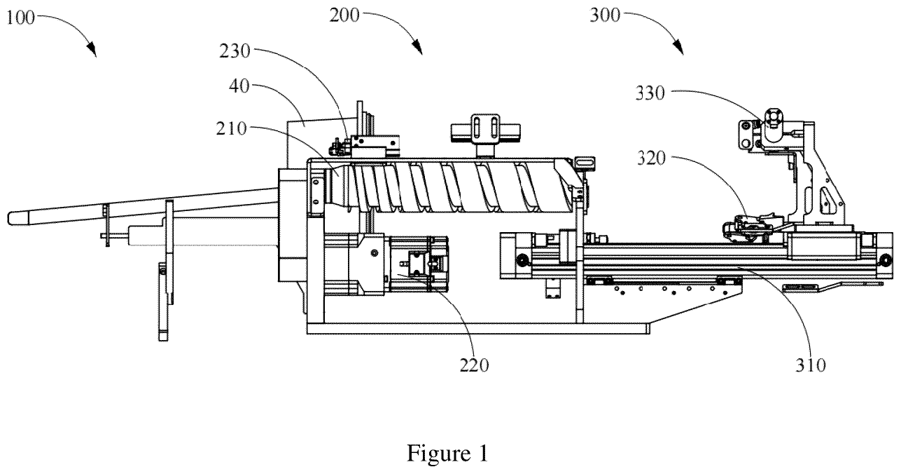

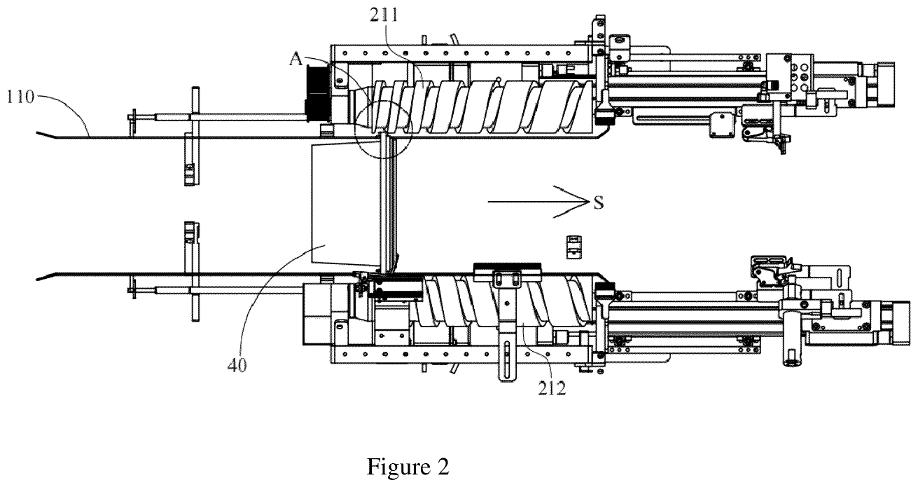

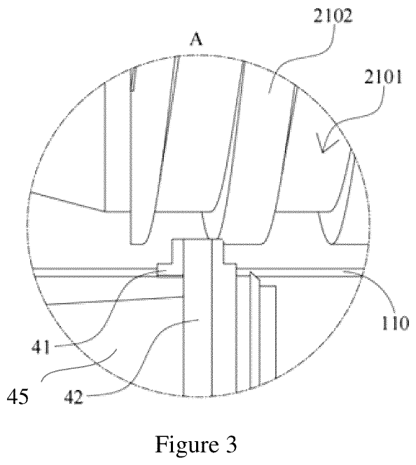

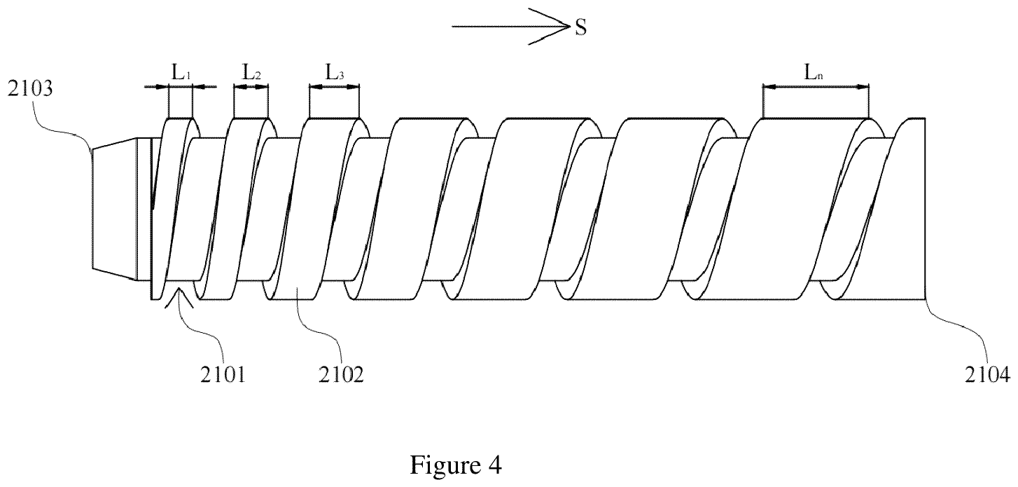

Referring to FIGS. 1-4, an embodiment of the present disclosure provides a bucket-feeding apparatus with bucket separation function which is configured for conveying buckets (40) and comprises a bucket-infeed assembly 100 and a bucket-separating assembly 200. The bucket-infeed assembly 100 includes at least a guide bracket 110 used to guide a conveying direction of buckets 40. The bucket-separating assembly 200 includes at least a wheel unit 210 and a power-source unit 220. The wheel unit 210 is connected to and driven by the at least a power-source unit 220 respectively. Each of the at least a wheel unit 210 defines a helical groove 2101 on a surface thereof.

Each of the buckets 40 includes a main body 45 and a rim portion 41 protruding form an outer surface of the main body 45. At least part of the rim portion 41 is received in the helical groove 2101. In the present embodiment, when the wheel unit 210 is driven to rotate, at least part of the rim portion 41 of the bucket 40 is in the helical groove 2101, and the moving direction of the bucket 40 is restricted by the guide bracket 110, so that the bucket 40 moves along a straight conveying direction S. Here, the conveying direction S is specifically the axial direction of the wheel unit 210.

In the present embodiment, the thread pitch of the helical groove 2101 gradually increases. Specifically, along the conveying direction S, the thread pitch of the helical groove 2101 gradually increases, so that the distance traveled by bucket 40 per unit of time gradually increases. The groove width of the helical groove 2101 maintains the same to ensure that the rim portion 41 is within the helical groove 2101 and drives the bucket 40. Because the thread pitch of the helical groove 2101 gradually increases and the groove width of the helical groove 2101 remains unchanged, the width of the thread tooth 2102 gradually increases. In the present embodiment, the thread pitch of the helical groove 2101 increases proportionally, and correspondingly the width of the thread tooth 2102 increases proportionally. Along a straight line parallel to the axis of the wheel unit 210, the widths of the thread teeth 2102 L1, L2, L3 . . . Ln increase proportionally. The proportional function may be a linear function, an exponential function, or a power function.

During the conveying process of the bucket-feeding apparatus, in order to reduce the storage space of the buckets 40, the buckets 40 are generally stored in a stacked manner. When processing the buckets 40, the stacked buckets 40 are separated into individual buckets 40. However, due to the characteristics of the buckets 40, the depth of the buckets 40 is large, and after the buckets 40 are stacked, a negative-pressure cavity is formed between adjacent buckets 40. When the wheel unit 210 drives the buckets 40 to move, the distance between adjacent buckets 40 gradually increases, the suction power generated by the negative-pressure cavity is decomposed many times, the load required during separation is reduced, and the stability of the bucket's incoming posture is ensured.

Further, the number of the at least a wheel unit 210 is two, the bucket-separating assembly (200) includes a first wheel 211 and a second wheel 212 in the two wheel units (210) respectively, the bucket 40 is clamped between the first wheel 211 and the second wheel 212. The helical grooves 2101 of the first wheel 211 and the second wheel 212 are symmetrically arranged, and the first wheel 211 and the second wheel 212 rotate in opposite directions. In the present embodiment, the first wheel 211 and the second wheel 212 are driven by the same power-source unit 220. The rotating directions of the first wheel 211 and the second wheel 212 are both towards the bucket 40 located between them. Specifically, the first wheel 211 is located on the left side of the bucket 40, the second wheel 212 is located on the right side of the bucket 40, the first wheel 211 rotates clockwise and the second wheel 212 rotates counterclockwise, and the guide bracket 110 is located below the bucket 40 so that the guide bracket 110 blocks the bucket 40 in the vertical direction. In the present specific embodiment, under the driving of the first wheel 211 and the second wheel 212, the bucket 40 has a tendency to move downward, but its position in the vertical direction is restricted by the guide bracket 110, so that the first wheel 211 and the second wheel 212 drive the bucket 40 to move along the conveying direction S while pressing the bucket 40 onto the guide bracket 110, preventing the bucket 40 from shifting out of the space among the first wheel 211, the second wheel 212 and the guide bracket 110.

In the present embodiment, the two ends of the wheel unit 210 are respectively the initial end 2103 that is at a relatively upstream of the conveying direction S and the terminal end 2104 at a relatively downstream of the conveying direction S, the thread pitch of the helical groove 2101 near the initial end 2103 being smaller than that near the terminal end 2104. The guide bracket 110 extends from the terminal end 2104 towards the initial end 2103, and finally protrudes outward from the initial end 2103. The portion of the guide bracket 110 extending out of the initial end 2103 serves as a loading position, and stacked buckets 40 enter the wheel unit 210 from the loading position.

Further, the number of guide brackets 110 is two, the two guide brackets 110 being arranged substantially in parallel. The buckets 40 are supported on the two guide brackets 110. The bucket 40 further includes a handle 42, two ends of the handle 42 being rotatably connected to the rim portion 41. Under the driving of the first wheel 211 and the second wheel 212, the two ends of the handle 42 are pressed onto the two guide brackets 110.

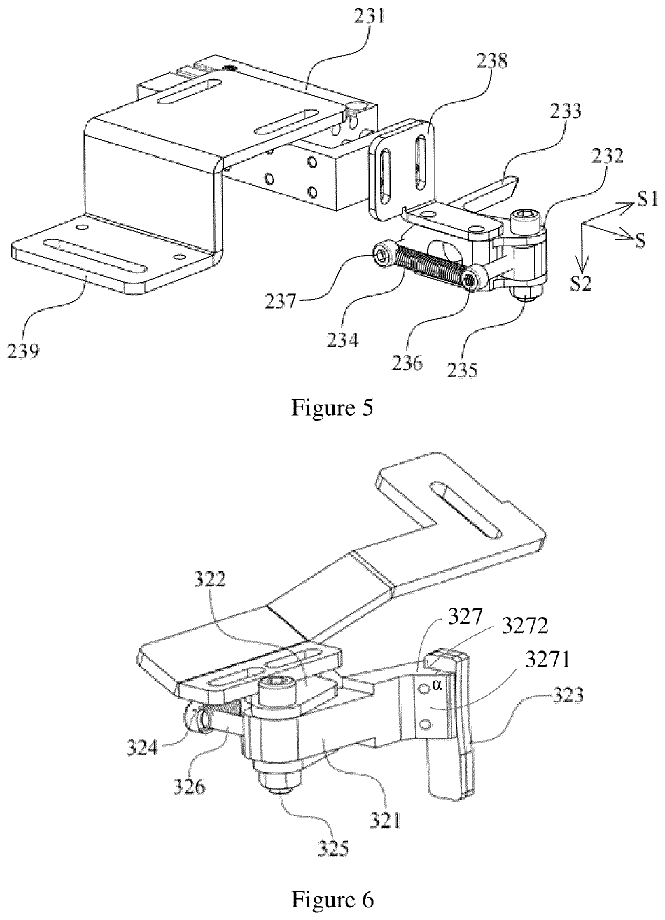

In some embodiments of the present disclosure, referring to FIG. 5, the bucket-separating assembly 200 further includes a positioning unit 230, the positioning unit 230 being arranged close to bucket-infeed assembly 100, namely, the initial end 2103, the positioning unit 230 being able to be connected to the handle 42 and drive the handle 42 to rotate relative to the main body 45.

Specifically, the positioning unit 230 includes a cylinder 231, a first rotating block 232, a stop block 233 and a first elastic member 234. The first rotating block 232 is connected to the power output end of the cylinder 231. Under the driving of the cylinder 231, the first rotating block 232 moves along the conveying direction. The first rotating block 232 is rotatably connected with the stop block 233, and the first elastic member 234 is connected between the first rotating block 232 and the stop block 233. The stop block 233 contacts the handle 42.

More specifically, the first rotating block 232 is rotatably connected with the stop block 233 as follows: the stop block 233 is L-shaped, one end of the stop block 233 is connected to the first rotating block 232 via a first pivot shaft 235 so that the stop block 233 can rotate relative to the first rotating block 232, and the other end of the stop block 233 is located in the moving path of the bucket 40. Due to the restriction of the first elastic member 234, the stop block 233 can rotate relative to the first rotating block 232 in one direction only.

The cylinder 231 pushes the first rotating block 232 and the stop block 233 to move towards the initial end 2103. During the movement, the stop block 233 contacts the handle 42. As the stop block 233 moves towards the stacked buckets 40, the stop block 233 rotates relative to the first rotating block 232 and the first elastic member 234 elastically deforms. After the stop block 233 passes over the handle 42 of the bucket 40 closest to the stop block 233, the stop block 233 is elastically restored by the first elastic member 234, the cylinder 231 then moves in the reverse direction to drive the first rotating block 232 and the stop block 233 to retreat, the stop block 233 thus contacts the handle 42 and drives the handle 42 to rotate relative to the main body 45, so that the handle 42 is separated from the rim portion 41 of the adjacent bucket 40 of the stacked buckets 40, thereby avoiding the problem that the separation of two buckets 40 is obstructed because of the handle 42 is restricted by the rim portion 41 during separation.

During the separating process, the handle 42 is easily connected with the rim portion 41 of the adjacent bucket 40; during separation, the handle 42 pulls the adjacent bucket 40 to move, resulting in difficulty in separating the two buckets 40 and affecting the separating effect. In the present embodiment, by providing the positioning unit 230, the handle 42 can be separated from the rim portion 41 of the adjacent bucket 40, preventing the adjacent bucket 40 from being driven during separation.

Further, the positioning unit 230 further includes a first limit rod 236 and a fixed rod 237, the first limit rod 236 being mounted on the stop block 233, the fixed rod 237 being mounted on the first rotating block 232, the first limit rod 236 and the fixed rod 237 being located on the same side of the positioning unit 230, and two ends of the first elastic member 234 being respectively connected to the first limit rod 236 and the fixed rod 237. When the stop block 233 rotates relative to the first rotating block 232, the distance between the first limit rod 236 and the fixed rod 237 changes, and the first elastic member 234 connected between the first limit rod 236 and the fixed rod 237 is stretched and elastically deforms.

Further, the positioning unit 230 further includes an adjusting bracket 238 and a movable bracket 239. The cylinder 231 is connected to the movable bracket 239, the first rotating block 232 is mounted on the adjusting bracket 238. The adjusting bracket 238 is connected to the power output end of the cylinder 231.

The position of the cylinder 231 can be adjusted relative to the movable bracket 239 along a first linear direction S1, and the positions of the adjusting bracket 238 and the first rotating block 232 can also be adjusted relative to the power output end of the cylinder 231 along a second linear direction S2; the first linear direction S1, the second linear direction S2, and the conveying direction S being mutually substantially perpendicular. The movable bracket 239 is mounted on the fixed base of the bucket-feeding apparatus. By means of the adjusting bracket 238 and the movable bracket 239, the position of the stop block 233 can be adjusted relative to the bucket 40 along the first linear direction S1 and the second linear direction S2, thereby adjusting the relative position of the stop block 233 and the bucket 40.

In some embodiments of the present disclosure, referring to FIG. 6, the bucket-feeding apparatus further includes a bucket-pushing assembly 300, the bucket-pushing assembly 300 being arranged on the side of the wheel unit 210 close to the terminal end 2104. The bucket-pushing assembly 300 includes a linear driving unit 310 and a clamp unit 320. The clamp unit 320 is mounted on the power output end of the linear driving unit 310.

Under the driving of the driving unit 310, the clamp unit 320 is driven to move from one end of the driving unit 310 to the other end, and the clamp unit 320 can move reciprocally between the two ends of the driving unit 310. One end of the driving unit 310 is located at the terminal end 2104, so that the bucket 40 located at the terminal end 2104 and having been separated is pushed to the other end of the driving unit 310 via the clamp unit 320. In the present embodiment, the number of bucket-pushing assemblies 300 is two, the two bucket-pushing assemblies 300 are symmetrically arranged.

More specifically, the clamp unit 320 includes a rotary push block 321, a second rotating block 322, a buffer member 323, and a second elastic member 324. The rotary push block 321 is rotatably connected to the second rotating block 322, and the second elastic member 324 is connected between the rotary push block 321 and the second rotating block 322. In the present embodiment, the structure of the clamp unit 320 is similar with that of the positioning unit 230. The rotary push block 321 can rotate relative to the second rotating block 322 in one direction only, the rotary push block 321 can pass over the rim portion 41 of the bucket 40 (at this point, the handle 42 is separated from the rim portion 41), and the rotary push block 321 contacts the rim portion 41 to drive the single bucket 40 to move along the track of the driving unit 310.

Further, the rotary push block 321 has, on its side facing the other bucket-pushing assembly 300, a protrusion 327, the protrusion 327 having a slope 3271 facing the terminal end 2104 and a mounting face 3272 opposite to the slope 3271. The buffer member 323 is connected to the mounting face 3272, the angle α between the slope 3271 and the mounting face 3272 is acute. When the rim portion 41 moves along the slope 3271, the rotary push block 321 is driven to rotate.

Further, the bucket-pushing assembly 300 further includes a second clamp unit 330. The second clamp unit 330 is mounted on the same power output end of the linear driving unit 310 together with the clamp unit 320. Specifically, the second clamp unit 330 and the clamp unit 320 are mounted on the same bracket, the bracket is connected to the power output end of the linear driving unit 310. The second clamp unit 330 and the clamp unit 320 are arranged vertically. The second clamp unit 330 is similar with the clamp unit 320, they pull the upper side and down side of the bucket 40, respectively, so that the bucket 40 stably pulled away from the stacked buckets 40.

The above embodiments are used to further illustrate the present disclosure, but the present disclosure is not limited to these specific embodiments. Any modification, equivalent substitution or improvement made within the spirit and principle of the present disclosure should be understood to fall within the protection scope of the present disclosure.

What is claimed is:

1. A bucket-feeding apparatus with bucket separation function, configured for conveying buckets (40), each of the buckets (40) comprising a main body (45), a rim portion (41) on an outer surface of the main body (45), and a handle (42); the bucket-feeding apparatus comprising:
a bucket-infeed assembly (100), each comprising two brackets (110) configured to guide a conveying direction (S) of the buckets (40); and
a bucket-separating assembly (200), comprising at least a power-source unit (220) and two wheel units (210) connected to and driven by the at least a power-source unit (220) respectively, wherein: the wheel unit (210) defines a helical groove (2101) on a surface thereof, a thread pitch of the at least a helical groove (2101) gradually increases; the helical groove (2101) is capable of receiving at least part of the rim portion (41);
the bucket-separating assembly (200) comprises a first wheel (211) and a second wheel (212) in the two wheel unit (210) respectively; the helical groove (2101) is defined on a surface of the first wheel (211) and the second wheel (212), the helical groove (2101) on the first wheel (211) and the helical groove (2101) on the second wheel (212) are symmetrically arranged; the first wheel (211) and the second wheel (212) rotate in opposite directions and are configured for clamping the bucket (40) therebetween;
the two guide brackets (110) are arranged substantially in parallel and configure for being pressed against by two ends of the handle (42);
the wheel unit (210) comprises an initial end (2103) and a terminal end (2104) at a relatively upstream and downstream of the conveying direction (S), respectively; the bucket-separating assembly (200) further comprises a positioning unit (230) arranged close to the initial end (2103), the positioning unit (230) is capable of being connected with the handle (42) and driving the handle (42) to rotate relative to the main body (45);
the positioning unit (230) comprises a cylinder (231), a first rotating block (232), a stop block (233) and a first elastic member (234);
the first rotating block (232) is connected to a power output end of the cylinder (231), under the driving of the cylinder (231) the first rotating block (232) moves along the conveying direction (S);
the first rotating block (232) is rotatably connected to the stop block (233), the first elastic member (234) is connected between the first rotating block (232) and the stop block (233); the stop block (233) is configured for contacting the handle (42).

2. The bucket-feeding apparatus according to claim 1, wherein the positioning unit (230) further comprises an adjusting bracket (238) and a movable bracket (239); the cylinder (231) is connected to the movable bracket (239), the first rotating block (232) is mounted on the adjusting bracket (238), the adjusting bracket (238) is connected to the power output end of the cylinder (231);
a position of the cylinder (231) is adjustable relative to the movable bracket (239) along a first linear direction, positions of the adjusting bracket (238) and the first rotating block (232) are adjustable relative to the power output end of the cylinder (231) along a second linear direction, the first linear direction, the second linear direction and the conveying direction (S) are mutually perpendicular.

3. The bucket-feeding apparatus according to claim 1, wherein a groove width of the helical groove (2101) maintains the same, and the thread pitch of the helical groove (2101) increases proportionally.

4. The bucket-feeding apparatus according to claim 1, further comprising at least a bucket-pushing assembly (300) arranged at the terminal end (2104) of the wheel unit (210);
each of the at least a bucket-pushing assembly (300) comprises a linear driving unit (310) and a clamp unit (320), the clamp unit (320) is mounted on the power output end of the linear driving unit (310).

5. The bucket-feeding apparatus according to claim 4, wherein each of the at least a bucket-pushing assembly (300) further includes a second clamp unit (330), the second clamp unit (330) is mounted on the same power output end of the linear driving unit (310) together with the clamp unit (320).

6. The bucket-feeding apparatus according to claim 4, wherein the number of the at least a bucket-pushing assembly (300) is two, the two bucket-pushing assemblies (300) are substantially symmetrically arranged;
the clamp unit (320) comprises a rotary push block (321), a second rotating block (322), a buffer member (323), and a second elastic member (324);
the rotary push block (321) is rotatably connected to the second rotating block (322), the second elastic member (324) is connected between the rotary push block (321) and the second rotating block (322);
the rotary push block (321) comprises a protrusion (327) on a side thereof facing another bucket-pushing assembly (300), the protrusion (327) comprises a slope (3271) facing the terminal end (2104) and a mounting face (3272) opposite to the slope (3271), the buffer member (323) is connected to the mounting face (3272), an angle (α) between the slope (3271) and the mounting face (3272) is an acute angle.

7. The bucket-feeding apparatus according to claim 5, wherein the second clamp unit (330) and the clamp unit (320) are vertically arranged for contacting an upper side and a down side of the bucket (40), respectively.
